(19) United States
(12) Patent Application Publication
(10) Pub. No.: US 2022/0138306 A1
(43) Pub. Date: May 5, 2022

(54) OFFLINE MULTI-FACTOR ONE-TIME PASSWORD AUTHENTICATION

(71) Applicant: ADOBE INC., SANJOSE, CA (US)

(72) Inventors: SORIN THEODOR MARINESCU, Craiova, Dolj (RO); Sparky Toews, Seattle, WA (US)

(21) Appl. No.: 17/089,895

(22) Filed: Nov. 5, 2020

(51) Int. Cl. G06F 21/40; G06F 21/36; G06F 21/60

(52) U.S. Cl. CPC G06F 21/40; G06F 2221/0755; G06F 21/602; G06F 21/36

(57) ABSTRACT

A server may encrypt an authentication signal using a public encryption key (e.g., a public encryption key that was generated together with a private encryption key stored on a user device pre-registered with the server). The server passes the encrypted authentication signal to a user agent (e.g., such as the web browser) and the user agent encodes the encrypted authentication signal into a machine-readable optical label. The user agent displays the machine-readable optical label for scanning by the user device. Accordingly, the user device may be unlocked by a user (e.g., using an unlock password or an unlock gesture), and the user device may scan the machine-readable optical label, decode the encrypted authentication signal encoded in the machine-readable optical label, decrypt the decoded authentication signal that was encrypted by the server, and generate an authentication code based on the decrypted authentication signal.

### BACKGROUND

The following relates generally to user authentication, and more specifically to offline authentication using an electronic device.

Computing systems (e.g., networks) may implement security measures to prevent unauthorized users (e.g., devices) from accessing system resources such as system information, data, hardware, software, applications, etc. For instance, computing systems may employ authentication procedures to authenticate a user (e.g., confirm a user's claimed identity) prior to granting the user access to restricted system resources. In an authentication procedure, a user may provide one or more credentials that may be authenticated by the computing system for the user to gain access to system resources. For example, a user may provide credentials such as a username, a password, a gesture, a biometric signature (e.g., a fingerprint), a personal identification number (PIN), etc. The computing system may compare credentials provided by the user with previously established credentials associated with the user to determine whether to permit or deny access requested by the user (e.g., where the previously established credentials may be registered with the computing system prior to the authentication procedure).

Multi-factor authentication (MFA) procedures may be implemented for enhanced security. MFA procedures may require multiple (i.e., at least two) credentials for user authentication. In some cases, the multiple credentials used in a MFA procedure may leverage a combination of different factors including possession, knowledge, and inherence. For instance, a three-factor authentication procedure may authenticate users by using a combination of a possession factor (e.g., a key card), a knowledge factor (e.g., a password), and an inherence factor (e.g., a fingerprint).

Aspects of authentication procedures may be designed based on the security application. For example, the number of user credentials and the type of user credentials solicited in an authentication procedure may depend on security requirements and the security setting (e.g., a computing system setting or a physical location setting), among other factors.

Conventional MFA devices and applications either assume the existence of a separate device that has access to the internet (or another communications network), or they store a secret key in multiple locations. However, in some cases users do not have a connected device. For example, the user could be outside of a service range, or may be located in a secure facility where online access is prohibited. Furthermore, storing a secret key in multiple places can be a security vulnerability. Therefore, there is a need in the art for MFA devices and applications that enable MFA to be performed without network connectivity, and without persistently storing multiple copies of a secret key.

### SUMMARY

The present disclosure describes systems and methods for performing multi-factor authentication (MFA) without a network connected device. Embodiments of the inventive concept include generate and display a machine-readable label, such as a quick response (QR) code, that includes an encrypted secret for authentication. A separate user device that includes a camera may read the QR code and decrypt the secret to generate a verification code to be used to authentication.

A method, apparatus, non-transitory computer readable medium, and system for offline authentication using an electronic device are described. Embodiments of the method, apparatus, non-transitory computer readable medium, and system are configured to receive an authentication signal, wherein the authentication signal is encrypted using a public encryption key and encoded as a machine-readable optical label, decrypt the authentication signal using a private encryption key, wherein the private encryption key is generated together with the public key and stored in a hardware security module of the electronic device, and generate an authentication code based on the decrypted authentication signal.

A method, apparatus, non-transitory computer readable medium, and system for offline authentication using an electronic device are described. Embodiments of the method, apparatus, non-transitory computer readable medium, and system are configured to generate an authentication signal using a public encryption key, display a machine-readable optical label representing the authentication signal to the electronic device, receive an authentication code from the electronic device in response to displaying the machine-readable optical label, wherein the authentication code is generated using a private encryption key generated together with the public key and stored in a local hardware security module of the electronic device, and authenticate a user based on the authentication code.

An apparatus, system, and method for offline authentication using an electronic device are described. Embodiments of the apparatus, system, and method are configured to an offline authentication component configured to receive an authentication signal and to generate an authentication code based on the authentication signal, wherein the authentication signal is encrypted using a public key and encoded as a machine-readable optical label and a hardware security module configured to decrypt the authentication signal using a private encryption key that is generated together with the public key.

### BRIEF DESCRIPTION OF THE DRAWINGS

FIG. 1 shows an example of a system for offline authentication according to aspects of the present disclosure.

FIG. 2 shows a block diagram of a system and a flow diagram for offline multi-factor one-time password (MFOTP) authentication according to an embodiment of the present disclosure.

FIG. 3 shows a flowchart for offline multi-factor one-time password (MFOTP) authentication according to aspects of the present disclosure.

FIG. 4 shows an example of a flowchart for offline MFOTP authentication according to aspects of the present disclosure.

FIG. 5 shows an example of stages of a sign in sequence according to aspects of the present disclosure.

FIGS. 6 through 9 show examples of a process for offline authentication using an electronic device according to aspects of the present disclosure.

### DETAILED DESCRIPTION

The present disclosure describes systems and methods for performing multi-factor authentication (MFA) without a network-connected device and without storing multiple copies of a secret key. Embodiments of the inventive concept include generating and displaying a machine-readable label. A separate user device reads the label and decrypts the secret to generate a verification code to be used for authentication.

MFA procedures use multiple independent means of identity verification for user authentication. In some cases, MFA procedures involve the use of cryptographically secure communication. However, conventional MFA devices and applications exchange cryptographic transmissions using network communication technology. Therefore, these conventional MFA devices and applications are inoperable when they lack network connectivity.

Alternatively, some MFA procedures perform offline authentication by storing a persistent secret key in multiple locations. For example, a device may store a secret key that the device uses to generate an authentication code, and a server may also store the secret key to validate the code (i.e., by generating the same code on the server). However, storing a secret key in multiple places can be a security vulnerability.

According to the inventive concept, embodiments of the present disclosure generate a temporary secret key on a server. The secret key is then encoded using machine-readable label. The machine-readable label can be received using a camera and decrypted using a private key stored on the device. Then, the user device may generate a validation code used for authentication. Therefore, embodiments of the present inventive concept include improved MFA applications capable of performing authentication using an offline device without storing persistent secret keys in multiple places.

Embodiments of the inventive concept include a registration (or onboarding) phase and a working phase. During the onboarding phase, a private/public key pair is generated on the user device, and the public key is electronically transferred to the server. During the working phase, a secret key is generated (and temporarily stored) on the server. The secret key is then transferred to the user device using an offline communication method (e.g., an optical machine-readable code). The user device then uses the secret key to generate a code for authentication. Embodiments of the inventive concept include user authentication before the private key can be used to decrypt values encrypted with the public key.

Thus, unlike conventional authentication procedures, the secret key is ephemeral. After a code has been validated (or the authentication session expires), the secret key is deleted from the device and server. Deleting the secret key after validation improves the security of the process since, in the case of a server-side compromise, only the public key can be leaked.

A valid code counts as two authentication factors - you knew how to unlock the phone, and you had the phone to generate the code. Because the secret key is encrypted with the public key from the device, receiving a valid code on the server means that the user has also been authenticated by the device (the private key is required to decrypt values encrypted with the public key).

According to the techniques described herein, an authentication procedure implements machine-readable optical labels that are scanned (e.g., or imaged) by a user device. The user device generates an authentication code based on a captured machine-readable optical label. The user may then enter the authentication code (e.g., into a user agent such as a web browser) for authentication. In some embodiments, the user device may be registered (e.g., by the system) for offline authentication procedures. During registration, the user device stores a private encryption key in a secure hardware module of the user device.

In some examples, a server encrypts an authentication signal using a public encryption key (e.g., a public encryption key that was generated together with the private encryption key stored on the user device). The server passes the encrypted authentication signal to a user agent (e.g., such as a web browser the user has requested access to) and the user agent encodes the encrypted authentication signal into a machine-readable optical label. Alternatively, sound transmissions, or other means of local communication, may be used such that the local communication does not depend on network connectivity.

The user agent displays the machine-readable optical label for scanning by the user device. Accordingly, the user device may scan the machine-readable optical label, decode the encrypted authentication signal that is encoded in the machine-readable optical label, decrypt the decoded authentication signal that was encrypted by the server, and generate an authentication code based on the decrypted authentication signal.

The techniques described herein may be implemented to provide an MFA solution that leverages secure authentication codes encrypted by a server (e.g., rather than user passwords maintained on a server). In some embodiments, the authentication procedures use time-based one-time password (TOTP) protocols, where a TOTP secret is generated for each authentication procedure and discarded after authentication of a user device (e.g., such that the TOTP secret is not permanently stored by the server). In some embodiments, the MFA solution is provided as a fallback authentication procedure (e.g., when a user device is offline, without push notifications, etc.).

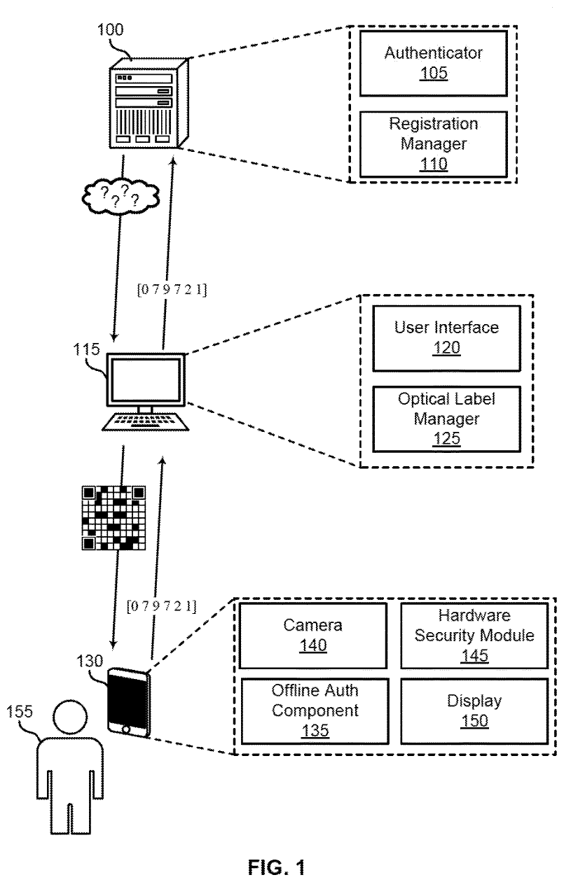

FIG. 1 shows an example of a system for offline authentication according to aspects of the present disclosure. The example shown includes server 100, user agent 115, device 130, and user 155. According to the techniques described herein, a user 155 requesting access to a user agent 115 (e.g., an application, a web browser, etc.) is authenticated with a server 100 using an MFA procedure carried out via user device 130, user agent 115, and server 100. In some cases, the authentication procedure includes an offline multi-factor one-time password (MFOTP) procedure.

User 155 may engage in a sign-in procedure to request access to user agent 115, which may prompt an authentication procedure (e.g., an offline MFOTP procedure) through server 100. In some embodiments, the access request includes a request for a machine-readable optical label (e.g., a QR code request). Upon receiving the request, server 100 (e.g., authenticator 105 of server 100) generates an authentication signal (e.g., a time-based one-time password (TOTP) secret) using a public encryption key. As shown in the example system in FIG. 1, server 100 then passes the authentication signal (e.g., the TOTP secret) to user agent 115. User agent 115 displays a machine-readable optical label representing the authentication signal (e.g., the user agent 115 may generate and display a QR code representing the TOTP secret).

Device 130 may then receive the authentication signal. In some embodiments, the authentication signal is encrypted using a public encryption key and is encoded as the machine-readable optical label. For instance, user 155 may capture an image of the machine-readable optical label using camera 140 of device 130. According to some embodiments, device 130 receives the authentication signal by decoding the machine-readable optical label to obtain a digital representation of the authentication signal. Device 130 then decrypts the digital representation of the authentication signal using a private encryption key. In some embodiments, the authentication signal is decoded by offline authentication component 135 of device 130, and the obtained digital representation of the authentication signal is then decrypted (e.g., separately) by hardware security module 145 of device 130. The hardware security module 145 of device 130 may securely store a private encryption key (e.g., a private encryption key generated together with the public key). Accordingly, hardware security module 145 may perform cryptographic operations to determine a TOTP secret from server 100. Additionally or alternatively, hardware security module 145 may decrypt the digital representation of the authentication signal using the stored private encryption key to obtain the TOTP secret, as the TOTP secret was encrypted in the authentication signal by server 100 (e.g., by authenticator 105) using a public encryption key corresponding to the private encryption key.

For instance, authenticated devices (e.g., device 130) may be registered with server 100 for offline authentication procedures (e.g., via registration manager 110 of server 100). For authentication procedures, authenticator 105 may generate private encryption keys together with (e.g., based on) public encryption keys (e.g., to enable cryptographic operations for encryption-based authentication procedures). In some embodiments, the private encryption key and the public encryption key are generated based on the registration of device 130. During a registration procedure, hardware security module 145 may store the private encryption key. Accordingly, device 130 may be registered for offline authentication procedures and may perform offline authentication procedures in accordance with various aspects of the techniques described herein.

In some embodiments, after the digital representation of the authentication signal is decrypted to obtain the TOTP secret, the hardware security module 145 passes the TOTP secret to offline authentication component 135. Offline authentication component 135 may use TOTP techniques to generate an authentication code based on the TOTP secret. Accordingly, device 130 may display (e.g., via display 150) the generated authentication code to user 155. User 155 may then enter the authentication code (e.g., [0 7 9 7 2 11]) to user agent 115 via user interface 120. In some embodiments, user interface 120 includes a code entry page displayed on an external device of user agent 115. After user 155 enters the authentication code, user agent 115 passes the entered authentication code to server 100. Server 100 checks the authentication code and determines whether the authentication code is valid (e.g., where user 130 is authenticated and allowed access to user agent 115) or invalid (e.g., where user 130 is not authenticated and is denied access to user agent 115). In some embodiments, the authentication code is a one-time numerical code (e.g., ‘0 7 9 7 2 11’). In some embodiments, the authentication code is discarded or deleted from memory (e.g., by the device 130, the server 100, or both) after a time duration or after device 130 is authenticated.

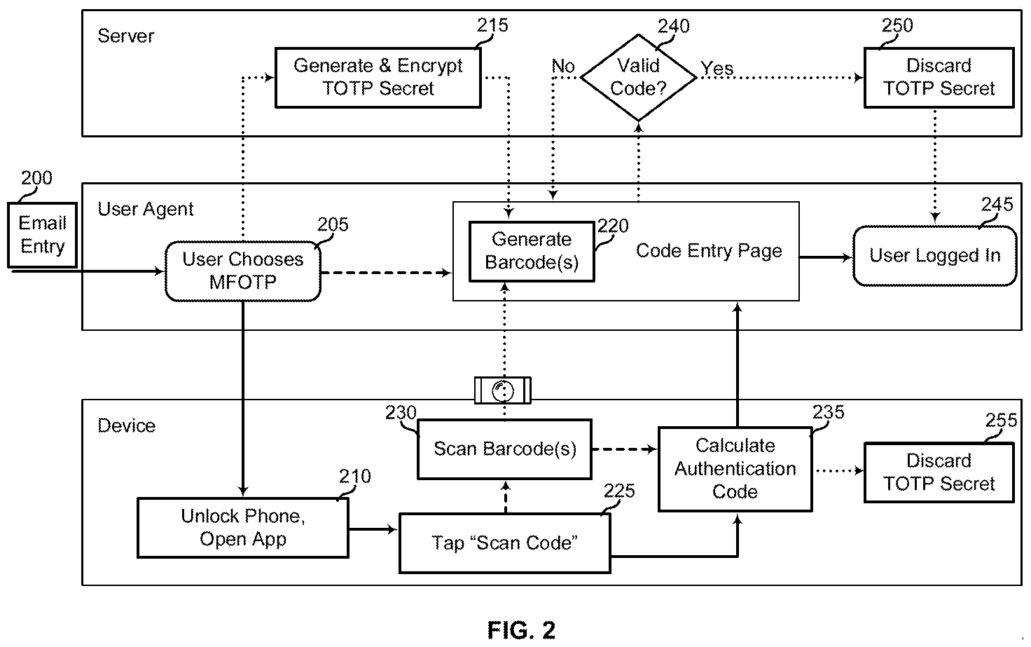

Server 100 is an example of, or includes aspects of, the corresponding element described with reference to FIG. 2. In one embodiment, server 100 includes authenticator 105 and registration manager 110. A server 100 (e.g., a computing system backend) provides one or more functions to user 155 linked by way of one or more of the various networks. In some cases, server 100 includes a single microprocessor board, which includes a microprocessor responsible for controlling aspects of the server 100. In some cases, a server 100 uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, server 100 is configured to send and receive hypertext markup language (HTML) formatted files (e.g., for displaying web pages). In various embodiments, server 100 comprises a general-purpose computing device, a personal computer, a laptop computer, a mainframe computer, a supercomputer, or any other suitable processing apparatus.

According to some embodiments, authenticator 105 generates an authentication signal using a public encryption key. In some examples, authenticator 105 receives an authentication code from the electronic device 130 in response to displaying the machine-readable optical label, where the authentication code is generated using a private encryption key generated together with the public key and stored in a local hardware security module 145 of the electronic device 130. In some examples, authenticator 105 authenticates a user 155 based on the authentication code. In some examples, authenticator 105 determines whether the authentication code is valid, where the user 155 is authenticated based on the determination. In some examples, authenticator 105 generates an additional authentication signal encrypted using the additional public encryption key.

According to some embodiments, registration manager 110 registers the electronic device 130 for offline authentication, where the private encryption key and the public encryption key are generated based on the registration of the electronic device 130. In some examples, registration manager 110 registers an additional device 130 for offline authentication, where an additional private encryption key and an additional public encryption key are generated based on the registration of the additional device 130. According to some embodiments, registration manager 110 registers the electronic device 130 for offline authentication, where the private encryption key and the public encryption key are generated based on the registration of the electronic device 130. In some examples, registration manager 110 registers an additional device 130 for offline authentication, where an additional private encryption key and an additional public encryption key are generated based on the registration of the additional device 130.

User agent 115 is an example of, or includes aspects of, the corresponding element described with reference to FIG. 2. In one embodiment, user agent 115 includes user interface 120 and optical label manager 125. User agent 115 generally refers to any computing system (e.g., a computing system frontend). In some embodiments, user agent 115 includes or refers to a website or a web browser. In some embodiments, user agent 115 includes or refers to an application such as a software application.

A user interface 120 may enable a user 155 to interact with user agent 115. In some embodiments, the user interface 120 may include or refer to an output device (e.g., such as a display or audio speaker) or an input device (e.g., such as a computer mouse, keyboards, keypads, trackballs, and voice recognition devices). An input component may include any combination of devices 130, providing user 155 to input information into a computing device, such as buttons, a keyboard, switches, and/or dials. Additionally or alternatively, the input component may include a touch-screen digitizer overlaid onto the display 150 that can sense touch and interact with the display 150. In some cases, a user interface 120 may be a graphical user interface (GUI). In some cases, an input device may include or refer to a remote control device interfaced with the user interface 120 directly or through an 10 controller module.

According to some embodiments, user interface 120 displays a machine-readable optical label representing the authentication signal to the electronic device 130. In some examples, user interface 120 receives user 155 input initiating an offline authentication mode, where the authentication signal is generated according to the offline authentication mode. In some examples, user interface 120 displays a code entry page, where the authentication code is received via the code entry page. In some examples, user interface 120 displays an additional machine-readable optical label representing the additional authentication signal to the electronic device 130.

Device 130 is an example of, or includes aspects of, the corresponding element described with reference to FIG. 2. In one embodiment, device 130 includes offline authentication component 135, camera 140, hardware security module 145, and display 150.

In some embodiments, elements perform the operations described herein via a combination of hardware and software. Software may include code to implement aspects of the present disclosure. Software may be stored in a non-transitory computer-readable medium such as system memory or other memory. In some cases, the software may not be directly executable by the processor but may cause a computer (e.g., when compiled and executed) to perform functions described herein.

According to some embodiments, offline authentication component 135 generates an authentication code based on the decrypted authentication signal. In some examples, offline authentication component 135 receives user 155 input initiating an offline authentication mode, where the authentication signal is received according to the offline authentication mode. In some examples, offline authentication component 135 determines that an unlocking process has been completed for an electronic device 130 containing the hardware security module 145, where the authentication code is generated based on the determination. In some examples, offline authentication component 135 accesses a camera 140 of the electronic device 130. In some examples, offline authentication component 135 decodes the machine-readable optical label to obtain a digital representation of the authentication signal, where the authentication signal is decrypted based on the digital representation. In some examples, offline authentication component 135 determines that the additional authentication signal is invalid based on the attempted decryption. In some examples, the authentication code includes a one-time numerical code.

According to some embodiments, offline authentication component 135 be configured to receive an authentication signal and to generate an authentication code based on the authentication signal, wherein the authentication signal is encrypted using a public key and encoded as a machine-readable optical label. In some examples, the machine-readable optical label includes a Quick Response (QR) code. In some examples, the offline authentication component 135 is further configured to receive user 155 input initiating an offline authentication mode, where the authentication signal is received according to the offline authentication mode.

Camera 140 is an example of, or includes aspects of, the corresponding element described with reference to FIG. 2. An image reading device, such as a camera 140 may optically capture images, such as text or photographs, and convert the captured images to a digital image. In some embodiments, camera 140 decodes a machine-readable optical label (e.g., a captured image of a QR code) to obtain a digital representation of the captured image (e.g., of the authentication signal). In some embodiments, camera 140 captures an image of a machine-readable optical label, and an integrated image signal processor (ISP) decodes the machine-readable optical label to obtain the digital representation of the captured image (e.g., of the authentication signal).

According to some embodiments, camera 140 receives an authentication signal, where the authentication signal is encrypted using a public encryption key and encoded as a machine-readable optical label. In some examples, camera 140 captures an image of the machine-readable optical label using the camera 140. In some examples, camera 140 receives an additional authentication signal encrypted using the additional public encryption key. In some examples, the machine-readable optical label includes a QR code. According to some embodiments, camera 140 be configured to capture an image of the machine-readable optical label.

In some examples, one or more of the operations described herein are performed by a system including a processor executing a set of codes to control functional elements of an apparatus (e.g., a device 130 may include a processor, a user agent 115 may include a processor, etc.). A processor is an intelligent hardware device (e.g., a general-purpose processing component, a digital signal processor (DSP), a central processing unit (CPU), a graphics processing unit (GPU), a microcontroller, an application-specific integrated circuit (ASIC), a field-programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special-purpose components for modem processing, baseband processing, digital signal processing, or transmission processing.

Additionally or alternatively, certain processes are performed using special-purpose hardware. For instance, device 130 may include hardware security module 145. Hardware security module 145 may include or refer to special-purpose hardware for performing cryptographic operations (e.g., such as storing cryptographic keys, encryption operations, decryption operations, etc.). Hardware security module 145 may include or refer to hardware secure elements or separate hardware chips that store keys and perform cryptographic operations with the stored keys (e.g., without exposing the private key to other hardware or applications of the device 130). In some embodiments, cryptographic operations are performed within secure hardware security module 145, where the device 130 main processor and the offline authentication component 135 have limited access to the hardware security module 145, enabling secure cryptographic operations by the hardware security module 145.

According to some embodiments, hardware security module 145 decrypts the authentication signal using a private encryption key, where the private encryption key is generated together with the public key and stored in a hardware security module 145 of the electronic device 130. In some examples, hardware security module 145 attempts to decrypt the additional authentication signal encrypted using the private encryption key stored in the local hardware security module 145 of the electronic device 130. According to some embodiments, hardware security module 145 be configured to decrypt the authentication signal using a private encryption key generated with the public key.

According to some embodiments, user 155 enters the authentication code into a code entry page displayed on an external device 130.

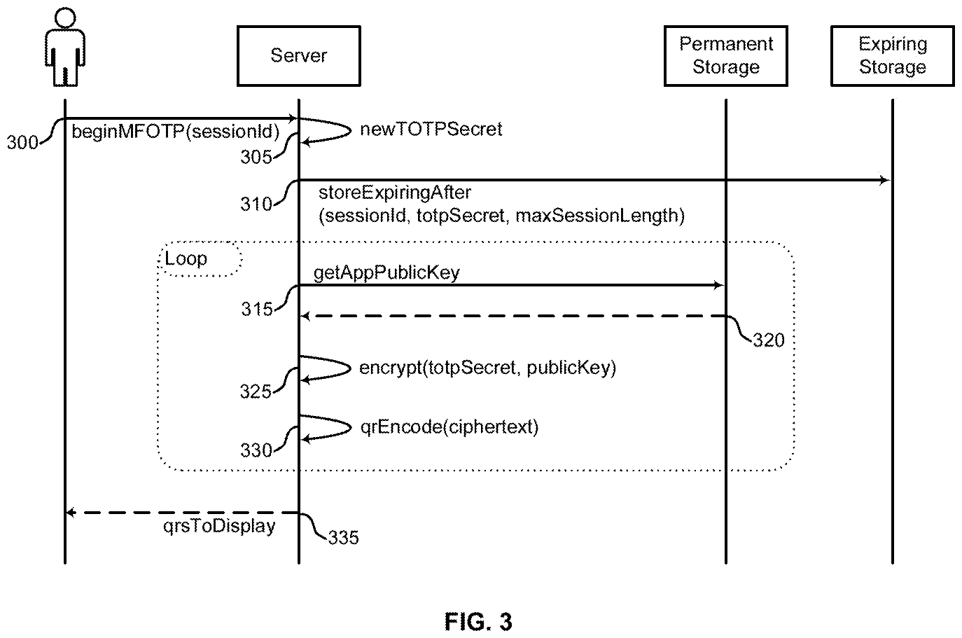

FIG. 2 shows an example of a flowchart for offline MFOTP authentication according to aspects of the present disclosure. In some examples, the operations shown in FIG. 3 are performed by a system with a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 200, a user may enter a form of identification such as a username, an email address, a personal identification number (PIN), etc. to a user agent. For instance, a user may type in an email address to a sign-in field of a web browser.

At operation 205, a user may select MFOTP procedure. In some cases, operation 205 may include a user requesting access to a user agent via requesting a machine-readable optical label (e.g., at operation 205, a user may request a QR code be displayed by the user agent).

At operation 210, a user may unlock a device (e.g., such as a mobile phone) and open an application associated with the user agent. For example, in some embodiments, a system mandates that a user device registered with the system be password protected or consider an unlock gesture for user access to the user device (e.g., the system mandates a password or unlock gesture be correctly entered prior to the unlocking of, or granting of access to, the user device). Accordingly, the password or unlock gesture used to unlock and access the user device serves as an authentication factor (e.g., a knowledge authentication factor based on user knowledge of the password or unlock gesture associated with the user device pre-registered with the system).

At operation 215, the server generates an authentication signal. In some embodiments, generating the authentication signal includes generating and encrypting a TOTP secret. As described herein, the server may perform encryption operations using a public encryption key (e.g., a public encryption key generated together with a private key stored by a user device registered for offline authentication). In embodiments where multiple devices are registered for offline authentication (e.g., when a user registers multiple devices for offline authentication), operation 215 includes generating multiple authentication signals corresponding to the number of registered devices (e.g., the number of registered devices corresponding to the identification information entered at operation 200). For instance, as additional devices are registered for offline authentication, additional private encryption key and public encryption key pairs are generated for each additional device registered. Accordingly, additional authentication signals are generated using additional public encryption keys, such that each generated authentication signal may be correctly decrypted by a corresponding registered device (e.g., where each registered device stores a private encryption key that may be used to correctly decrypt an authentication signal encrypted using the public key corresponding to the private encryption key stored on the user device the user is using out of the set of registered user devices).

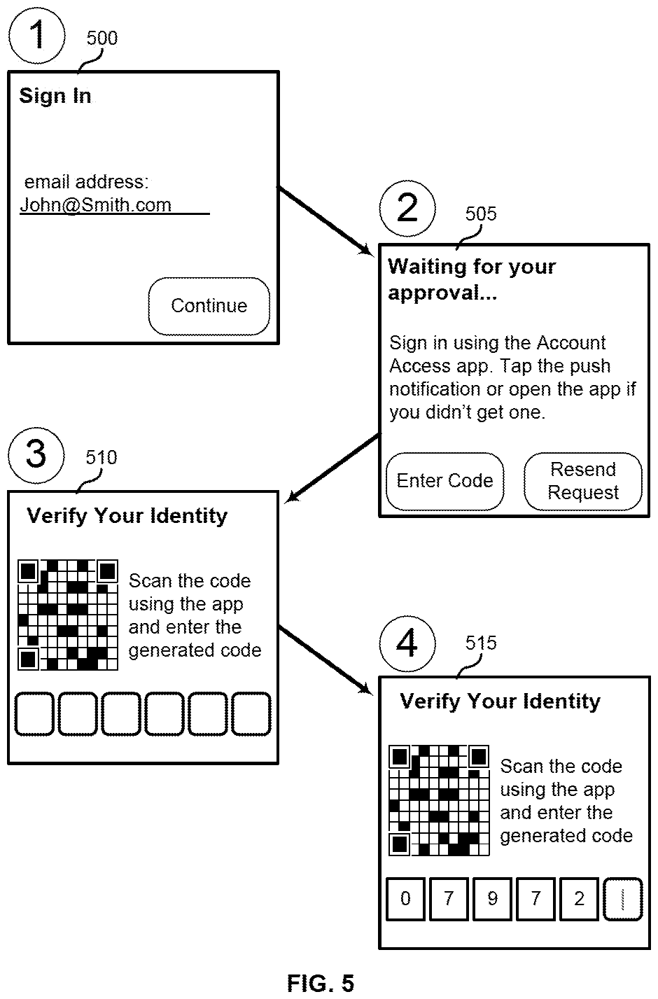

At operation 220, the user agent generates a machine-readable optical label (e.g., a barcode) for authentication signals (e.g., encrypted TOTP secrets) generated by the server. For instance, the user agent may display a code entry page (e.g., an authentication code entry window as further described herein, for example, with reference to FIG. 5). In some embodiments, the code entry page displays the machine-readable optical label for scanning or imaging by a user device involved in the authentication procedure. In some embodiments, the machine-readable optical label is a QR code. Generally, the machine-readable optical label includes or refers to any two-dimensional (2D) barcode. For instance, the machine-readable optical label may be determined or generated based on the density of the machine-readable optical label and the amount of information to be represented by the machine-readable optical label. In some embodiments, the machine-readable optical label is an encoded representation of an authentication signal (e.g., an encrypted TOTP secret). In some embodiments, the machine-readable optical label is an encoded representation of additional information (e.g., such as instructions, data, machine-readable optical label orientation information, etc.).

At operation 225, the user may initiate scanning of the machine-readable optical label displayed by the user agent (e.g., the machine-readable optical label displayed via a code entry page). In some embodiments, operation 225 includes a user tapping a “scan code” option. In some embodiments, operation 225 causes the user device to access a camera. At operation 230, the user device receives an authentication signal, where the authentication signal is encrypted using a public encryption key and is encoded as a machine-readable optical label. In some embodiments, the user device captures an image of the machine-readable optical label using the camera (e.g., the camera or image sensor is used to scan a barcode).

At operation 235, the user device calculates an authentication code. In some embodiments, the user device decrypts the authentication signal using a private encryption key. The private encryption key is generated together with the public key and stored in a hardware security module of the electronic device, and generates an authentication code based on the decrypted authentication signal. As described in more detail herein, the user device may include a secure hardware module (e.g., hardware secure elements of the user device) and an offline authentication component (e.g., an authenticator of the user device). The offline authentication component receives the authentication signal and passes the authentication signal to the secure hardware module for secure cryptographic operations. The hardware secure module securely decrypts the decoded authentication signal and passes back the decrypted authentication signal (e.g., the decrypted TOTP secret) to the offline authentication component, where the offline authentication component generates an authentication code based on the decrypted authentication signal. In some embodiments, the user device (e.g., an offline authentication component) generates the authentication code using TOTP techniques to generate codes based on the obtained decrypted authentication signal (e.g., TOTP techniques use the obtained decrypted TOTP secret to generate the authentication code).

In some embodiments, additional (e.g., multiple) authentication signals are received in operation 230. For instance, in examples where a user has registered multiple devices for offline authentication, a machine-readable optical label for each registered device (e.g., each registered device associated with the user identification information entered in operation 200) is generated and displayed in operation 220. In such cases, several machine-readable optical labels may be captured by the user device such that the user device may generate an authentication code based on one of the machine-readable optical labels. In some embodiments, the machine-readable optical labels are displayed sequentially. In some embodiments, the machine-readable optical labels are displayed at the same time separated in space across the code entry page. In some embodiments, machine-readable optical labels are displayed in sequence until a machine-readable optical label is correctly used to generate an authentication code by the user device (e.g., machine-readable optical labels are displayed until the machine-readable optical label representing the authentication signal encrypted using a public encryption key corresponding to the private encryption key stored by the user device is captured by the user device and used to successfully generate an authentication code).

In some embodiments, the machine-readable optical labels may be displayed based on some time interval. In some embodiments, machine-readable optical labels may be displayed until the user device determines another machine-readable optical label (e.g., a machine-readable optical label generated based on another public key) is requested. In some embodiments, operation 230 includes the user device scanning multiple (e.g., each) machine-readable optical label, where some attempts may fail until the machine-readable optical label meant for that particular user device is displayed (e.g., until the machine-readable optical label representing the authentication signal encrypted using the public encryption key generated with the private encryption key stored in the particular user device is displayed). For instance, the user device may scan (e.g., capture images) of displayed machine-readable optical labels repeatedly (e.g., continuously) until a machine-readable optical label is successfully decoded, decrypted, used to generate an authentication code using TOTP techniques, or any combination thereof

In some embodiments, operation 235 includes entry of the generated authentication code into a code entry page of the user agent. For instance, a user device may generate and display the calculated authentication code and a user may manually enter the authentication code into a code entry page of the user agent. The user agent may pass the entered authentication code to the server. At operation 240, the server may check the entered authentication code (e.g., the server may validate the entered authentication code). If the authentication code is not valid, the server may indicate such to the user agent. In some embodiments, the user agent may regenerate the machine-readable optical label. In some embodiments, the user agent may display another machine-readable optical label (e.g., a machine-readable optical label generated using a different authentication signal from the server).

If the authentication code is valid, operation 245 includes the user (e.g., and the user device) being authenticated and the user successfully being logged into the user agent. In some embodiments (e.g., upon successful authentication of the user), operation 250 includes the server discarding the authentication signal (e.g., the TOTP secret) and operation 255 includes the user device discarding the TOTP secret. Accordingly, the techniques described herein may provide for the discarding of TOTP secrets and corresponding authentication codes after successful authentication procedures (e.g., such that TOTP secrets and corresponding authentication codes do not need to be stored and maintained at the server for extended periods of time or periods of time outside of an active authentication procedure).

The techniques described herein provide for secure MFA procedures (e.g., that may be securely and efficiently performed offline). The authentication codes generated and entered for authentication (e.g., through operation 235) may provide for such multiple authentication factors due to the user knowledge factor (e.g., the user device unlock password or unlock gesture of operation 210) and the possession factor (e.g., the private key stored in a hardware secure module of the user device used for successful decryption operations and generation of a valid authentication code).

Moreover, TOTP secrets may not necessarily be stored on the server for extended periods of time. For instance, one or more aspects of the techniques described herein eliminate the need for TOTP secrets to be stored on the server outside of an active authentication procedure (e.g., outside of a time interval between operation 205 and operation 250). Authentication signals (e.g., TOTP secrets) may be generated and encrypted for the generation of machine-readable optical labels by the user agent, and the authentication signals (e.g., TOTP secrets) may be stored until the user enter a valid authentication code at which point the server may delete the authentication signals (e.g., TOTP secrets). The server may thus store public encryption keys for extended durations (e.g., which are public). Discarding authentication signals (e.g., TOTP secrets) after user validation may thus reduce the potential of security breaches due to any hacking of the server or any reuse of the same authentication signals (e.g., TOTP secrets). In some cases, the generated authentication codes (e.g., of operation 235) may be more secure than the alternative of using passwords. For instance, the authentication codes may be generated once (e.g., OTP versus a password used routinely by a user) and may replace more complex passwords (e.g., passwords with a length threshold, set character types, or other complexities) with a same or similar level of security.

FIG. 3 shows an example of a flowchart for offline MFOTP authentication according to aspects of the present disclosure. In some examples, these operations are performed by a system with a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 300, a user may begin an MFOTP session. In some embodiments, the user sends selects the MFOTP procedure (e.g., via a user agent or via a user device), and a request is passed to the server (e.g., a ‘beginMFOTP’ request that includes a session identification, ‘sessionId’, associated with the session request).

At operation 305, the server may generate an authentication signal. In some embodiments, the server generates a new TOTP secret (e.g., ‘newTOTPSecret’).

At operation 310, the server passes the authentication signal (e.g., the TOTP secret) to expiring storage (e.g., as the authentication signal may be discarded after a successful authentication procedure, as described in more detail herein). In some embodiments, the server initiates a ‘storeExpiringAfter’ command (e.g., to expiring storage) that includes an identifier of the session associated with the TOTP secret (‘sessionId’), the TOTP secret value (‘totpSecret’), and a time duration for storage of the command (‘maxSessionLength’) prior to discarding. In some cases, expiring storage may refer to memory.

After the authentication signal is established (e.g., after the TOTP secret is generated and stored in expiring storage), the server may encrypt authentication signals for registered user devices (e.g., for one or more registered offline authenticated devices associated with the user). For instance, the server obtains a public key from permanent storage via initiating a ‘getAppPublicKey’ command.

At operation 315, the command is passed to permanent storage, and at operation 320 the public key requested by the command is obtained by the server from the permanent storage. At operation 325, the server encrypts an authentication signal (e.g., the server uses an encryption function to encrypt the TOTP secret using the obtained public encryption key).

At operation 330, the server encodes the encrypted authentication signal (e.g., into a machine-readable optical label, such as a QR code). As described in more detail herein, operations 315 through 330 may be performed as a loop (e.g., a loop function) to encode encrypted authentication signals into a machine-readable optical label for each registered device. For example, the loops may include the server obtaining a public encryption key for a corresponding private encryption key stored in each registered device associated with the user. Operations 325 and 330 may be performed for each loop to generate a machine-readable optical label for each registered device associated with the user.

At operation 335, the machine-readable optical label code(s) may be displayed (e.g., and the user may scan the machine-readable optical labels as described in more detail herein). In some cases, the server may pass a ciphertext encrypted authentication signal to a user agent for the user agent to encode the ciphertext encrypted authentication signal in a machine-readable optical label (e.g., in some cases, the server may send a ‘qrsToDisplay’ command to a user agent for the user agent to encode the ciphertext encrypted authentication signal in a machine-readable optical label).

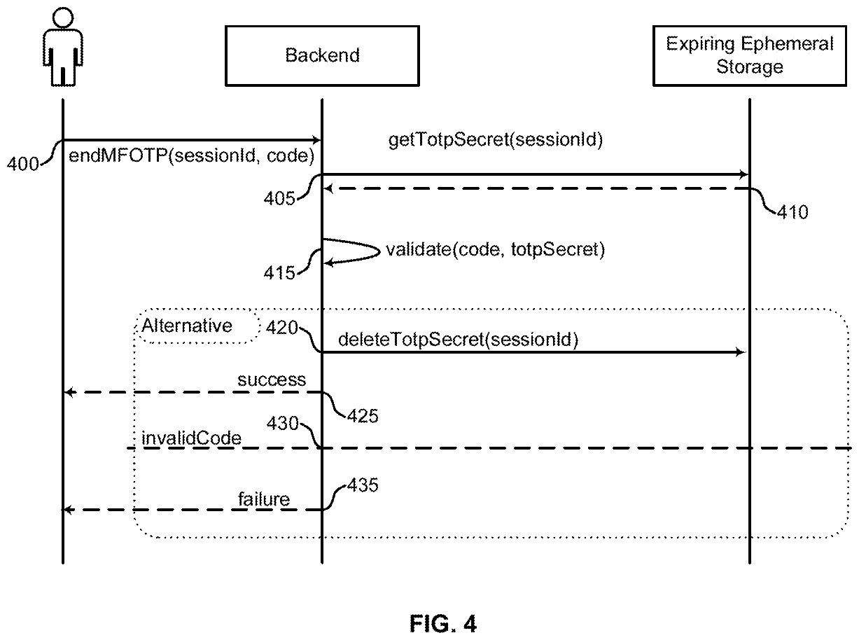

FIG. 4 shows an example of a flowchart for offline MFOTP authentication according to aspects of the present disclosure. In some examples, these operations are performed by a system with a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 400, the user may enter an authentication code that may be included in a command to finish the MFOTP session. In some embodiments, an ‘endMFOTP’ command may include the ‘sessionId’ and the authentication code (e.g., ‘code’). Upon receiving the authentication code and the sessionld, the backend may obtain the TOTP secret from expiring ephemeral storage.

In some embodiments, operation 405 includes the backend passing a command to obtain the TOTP secret from expiring ephemeral storage. The command (e.g., ‘getTotpSecret’) includes an indication of the sessionld. At operation 410, TOTP secret is obtained from the expiring ephemeral storage (e.g., based on the sessionld).

At operation 415, the backend validates the code (e.g., the authentication code entered by the user) based on the obtained TOTP secret associated with the sessionld. If the authentication code is valid (e.g., and the user is authenticated), the backend may command the TOTP secret to be discarded. For instance, operation 420 includes a ‘deleteTotpSecret’ command that includes the sessionld. Accordingly, the TOTP secret associated with the sessionld may be discarded. At operation 425, the backend indicates success to the user. Alternatively, if the authentication code is determined to be invalid at operation 430, the backend may indicate a failure to the user at operation 435. In some cases, the TOTP secret may be discarded at operation 420 regardless of whether the authentication code was determined to be valid or invalid (e.g., if the authentication code is determined to be invalid, the TOTP secret may still be discarded, and a new TOTP secret may be generated upon the user requesting another MFOTP session).

FIG. 5 shows example stages of a sign in sequence according to aspects of the present disclosure. The example shown includes example sign in window 500, example authentication signal request window 505, example authentication signal scanning window 610, and example authentication code entry window 515.

Example sign in window 500 illustrates an example sign in window where a user may enter user identification (e.g., as further described herein, for example, with reference to FIG. 2). For example, a user may enter an email address into example sign in window 500. Example sign in window 500 may include a continue button, which may submit user identification information entered into a field of the example sign in window 500.

After entry of user identification information, an example authentication signal request window 505 may be displayed. Example authentication signal request window 505 may prompt a user to enter a code or request a code be resent. For example, the user may elect to authorize an application using an online authentication process or enter a code using an offline authentication process.

If the user elects to use the offline authentication mode, example authentication signal scanning window 510 may display a machine-readable optical label (e.g., a QR code) as well as one or more authentication code entry fields. In some embodiments, a user scans (e.g., captures an image of) the machine-readable optical label and the user device decodes and decrypts the machine-readable optical label (e.g., in accordance with the techniques described herein). The decrypted machine-readable optical label is used by the user device to generate an authentication code.

Example authentication code entry window 515 includes the user entry of at least a portion of such a generated authentication code. For instance, the example authentication code entry window 515 includes user entry of ‘0 7 9 7 2’ which may represent a portion or all of an authentication code.

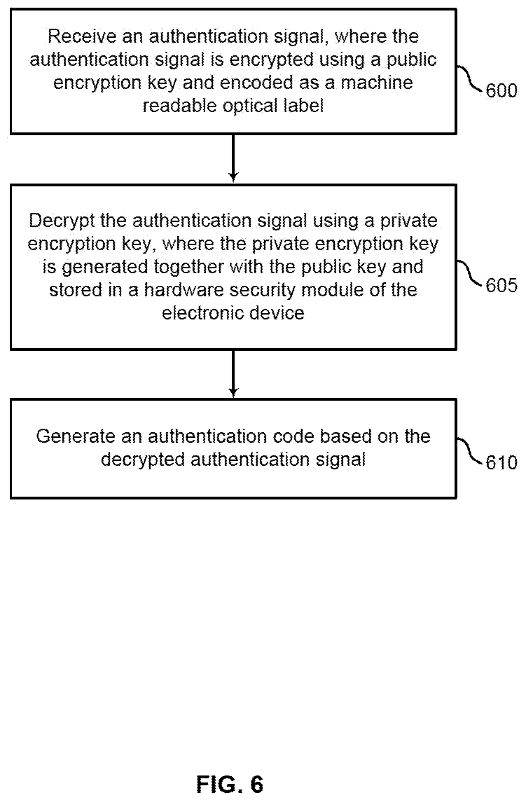

FIG. 6 shows an example of a process for offline authentication using an electronic device according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 600, the system receives an authentication signal, where the authentication signal is encrypted using a public encryption key and encoded as a machine-readable optical label. In some cases, the operations of this step refer to, or may be performed by, a camera as described with reference to FIGS. 1 and 2.

At operation 605, the system decrypts the authentication signal using a private encryption key, where the private encryption key is generated together with the public key and stored in a hardware security module of the electronic device. In some cases, the operations of this step refer to, or may be performed by, a hardware security module as described with reference to FIG. 1.

At operation 610, the system generates an authentication code based on the decrypted authentication signal. In some cases, the operations of this step refer to, or may be performed by, an offline authentication component as described with reference to FIG. 1.

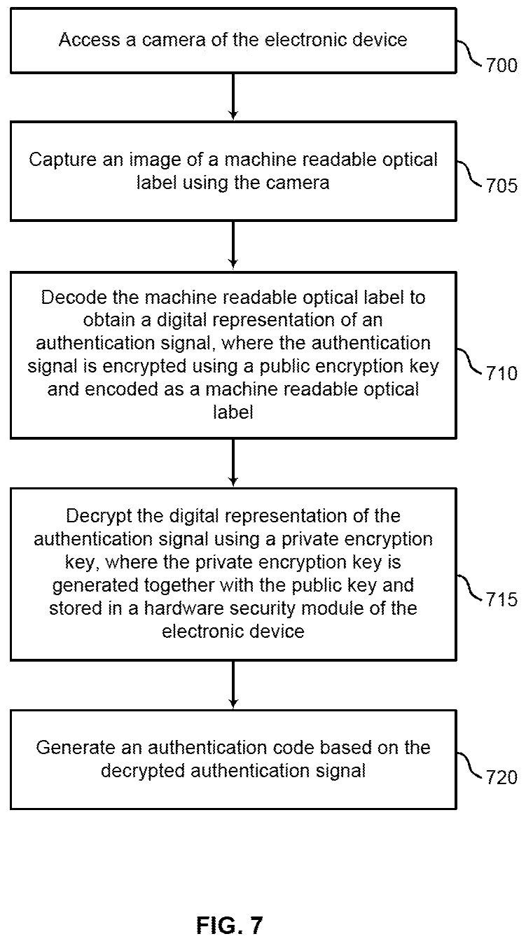

FIG. 7 shows an example of a process for offline authentication using an electronic device according to aspects of the present disclosure. In some examples, these operations are performed by a system with a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 700, the system accesses a camera of the electronic device. In some cases, the operations of this step refer to, or may be performed by, an offline authentication component as described with reference to FIG. 1.

At operation 705, the system captures an image of a machine-readable optical label using the camera. In some cases, the operations of this step refer to, or may be performed by, a camera as described with reference to FIGS. 1 and 2.

At operation 710, the system decodes the machine-readable optical label to obtain a digital representation of an authentication signal, where the authentication signal is encrypted using a public encryption key and encoded as a machine-readable optical label. In some cases, the operations of this step refer to, or may be performed by, an offline authentication component as described with reference to FIG. 1.

At operation 715, the system decrypts the digital representation of the authentication signal using a private encryption key, where the private encryption key is generated together with the public key and stored in a hardware security module of the electronic device. In some cases, the operations of this step refer to, or may be performed by, a hardware security module as described with reference to FIG. 1.

At operation 720, the system generates an authentication code based on the decrypted authentication signal. In some cases, the operations of this step refer to, or may be performed by, an offline authentication component as described with reference to FIG. 1.

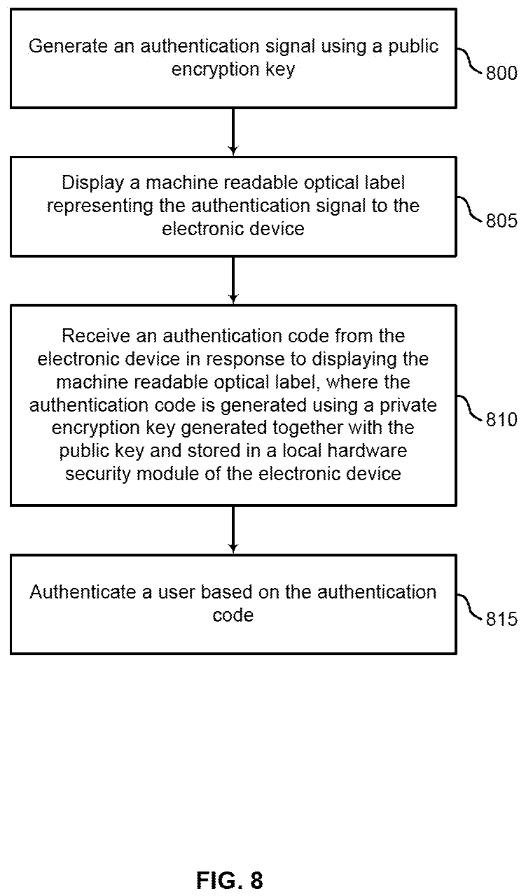

FIG. 8 shows an example of a process for offline authentication using an electronic device according to aspects of the present disclosure. In some examples, these operations are performed by a system with a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 800, the system generates an authentication signal using a public encryption key. In some cases, the operations of this step refer to, or may be performed by, an authenticator as described with reference to FIG. 1.

At operation 805, the system displays a machine-readable optical label representing the authentication signal to the electronic device. In some cases, the operations of this step refer to, or may be performed by, a user interface as described with reference to FIG. 1.

At operation 810, the system receives an authentication code from the electronic device in response to displaying the machine-readable optical label, where the authentication code is generated using a private encryption key generated together with the public key and stored in a local hardware security module of the electronic device. In some cases, the operations of this step refer to, or may be performed by, an authenticator as described with reference to FIG. 1.

At operation 815, the system authenticates a user based on the authentication code. In some cases, the operations of this step refer to, or may be performed by, an authenticator as described with reference to FIG. 1.

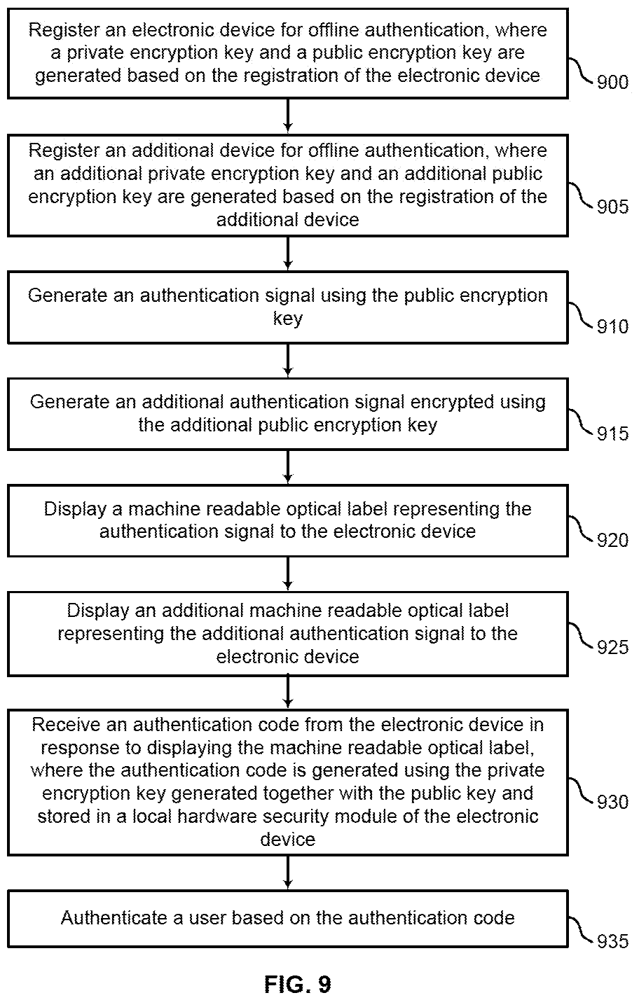

FIG. 9 shows an example of a process for offline authentication using an electronic device according to aspects of the present disclosure. In some examples, these operations are performed by a system with a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 900, the system registers an electronic device for offline authentication, where a private encryption key and a public encryption key are generated based on the registration of the electronic device. In some cases, the operations of this step refer to, or may be performed by, a registration manager as described with reference to FIG. 1.

At operation 905, the system registers an additional device for offline authentication, where an additional private encryption key and an additional public encryption key are generated based on the registration of the additional device. In some cases, the operations of this step refer to, or may be performed by, a registration manager as described with reference to FIG. 1.

At operation 910, the system generates an authentication signal using the public encryption key. In some cases, the operations of this step refer to, or may be performed by, an authenticator as described with reference to FIG. 1.

At operation 915, the system generates an additional authentication signal encrypted using the additional public encryption key. In some cases, the operations of this step refer to, or may be performed by, an authenticator as described with reference to FIG. 1.

At operation 920, the system displays a machine-readable optical label representing the authentication signal to the electronic device. In some cases, the operations of this step refer to, or may be performed by, a user interface as described with reference to FIG. 1.

At operation 925, the system displays an additional machine-readable optical label representing the additional authentication signal to the electronic device. In some cases, the operations of this step refer to, or may be performed by, a user interface as described with reference to FIG. 1.

At operation 930, the system receives an authentication code from the electronic device in response to displaying the machine-readable optical label, where the authentication code is generated using the private encryption key generated together with the public key and stored in a local hardware security module of the electronic device. In some cases, the operations of this step refer to, or may be performed by, an authenticator as described with reference to FIG. 1.

At operation 935, the system authenticates a user based on the authentication code. In some cases, the operations of this step refer to, or may be performed by, an authenticator as described with reference to FIG. 1.

Accordingly, the present disclosure includes the following embodiments.

A method for offline authentication using an electronic device is described. Embodiments of the method are configured to receiving an authentication signal, wherein the authentication signal is encrypted using a public encryption key and encoded as a machine- readable optical label, decrypting the authentication signal using a private encryption key, wherein the private encryption key is generated together with the public key and stored in a hardware security module of the electronic device, and generating an authentication code based on the decrypted authentication signal.

An apparatus for offline authentication is described. The apparatus includes a processor, memory in electronic communication with the processor, and instructions stored in the memory. The instructions are operable to cause the processor to receive an authentication signal, wherein the authentication signal is encrypted using a public encryption key and encoded as a machine-readable optical label, decrypt the authentication signal using a private encryption key, wherein the private encryption key is generated together with the public key and stored in a hardware security module of the electronic device, and generate an authentication code based on the decrypted authentication signal.

A non-transitory computer-readable medium storing code for offline authentication using an electronic device is described. In some examples, the code comprises instructions executable by a processor to receive an authentication signal, wherein the authentication signal is encrypted using a public encryption key and encoded as a machine-readable optical label, decrypt the authentication signal using a private encryption key, wherein the private encryption key is generated together with the public key and stored in a hardware security module of the electronic device, and generate an authentication code based on the decrypted authentication signal.

A system for offline authentication using an electronic device is described. Embodiments of the system are configured to receiving an authentication signal, wherein the authentication signal is encrypted using a public encryption key and encoded as a machine-readable optical label, decrypting the authentication signal using a private encryption key, wherein the private encryption key is generated together with the public key and stored in a hardware security module of the electronic device, and generating an authentication code based on the decrypted authentication signal.

Some examples of the method, apparatus, non-transitory computer-readable medium, and system described above further include receiving user input initiating an offline authentication mode, wherein the authentication signal is received according to the offline authentication mode. Some examples of the method, apparatus, non-transitory computer-readable medium, and system described above further include determining that an unlocking process has been completed for an electronic device containing the hardware security module, wherein the authentication code is generated based on the determination.

Some examples of the method, apparatus, non-transitory computer-readable medium, and system described above further include accessing a camera of the electronic device. Some examples further include capturing an image of the machine-readable optical label using the camera. Some examples of the method, apparatus, non-transitory computer-readable medium, and system described above further include decoding the machine-readable optical label to obtain a digital representation of the authentication signal, wherein the authentication signal is decrypted based on the digital representation.

Some examples of the method, apparatus, non-transitory computer-readable medium, and system described above further include entering the authentication code into a code entry page displayed on an external device. Some examples of the method, apparatus, non-transitory computer-readable medium, and system described above further include registering the electronic device for offline authentication, wherein the private encryption key and the public encryption key are generated based on the registration of the electronic device.

Some examples of the method, apparatus, non-transitory computer-readable medium, and system described above further include registering an additional device for offline authentication, wherein an additional private encryption key and an additional public encryption key are generated based on the registration of the additional device. Some examples further include receiving an additional authentication signal encrypted using the additional public encryption key.

Some examples further include attempting to decrypt the additional authentication signal encrypted using the private encryption key stored in the local hardware security module of the electronic device. Some examples further include determining that the additional authentication signal is invalid based on the attempted decryption. In some examples, the machine-readable optical label comprises a QR code. In some examples, the authentication code comprises a one-time numerical code.

A method for offline authentication using an electronic device is described. Embodiments of the method are configured to generating an authentication signal using a public encryption key, displaying a machine-readable optical label representing the authentication signal to the electronic device, receiving an authentication code from the electronic device in response to displaying the machine-readable optical label, wherein the authentication code is generated using a private encryption key generated together with the public key and stored in a local hardware security module of the electronic device, and authenticating a user based on the authentication code.

An apparatus for offline authentication is described. The apparatus includes a processor, memory in electronic communication with the processor, and instructions stored in the memory. The instructions are operable to cause the processor to generate an authentication signal using a public encryption key, display a machine-readable optical label representing the authentication signal to the electronic device, receive an authentication code from the electronic device in response to displaying the machine-readable optical label, wherein the authentication code is generated using a private encryption key generated together with the public key and stored in a local hardware security module of the electronic device, and authenticate a user based on the authentication code.

A non-transitory computer-readable medium storing code for offline authentication using an electronic device is described. In some examples, the code comprises instructions executable by a processor to: generate an authentication signal using a public encryption key, display a machine-readable optical label representing the authentication signal to the electronic device, receive an authentication code from the electronic device in response to displaying the machine-readable optical label, wherein the authentication code is generated using a private encryption key generated together with the public key and stored in a local hardware security module of the electronic device, and authenticate a user based on the authentication code.

A system for offline authentication using an electronic device is described. Embodiments of the system are configured to generating an authentication signal using a public encryption key, displaying a machine-readable optical label representing the authentication signal to the electronic device, receiving an authentication code from the electronic device in response to displaying the machine-readable optical label, wherein the authentication code is generated using a private encryption key generated together with the public key and stored in a local hardware security module of the electronic device, and authenticating a user based on the authentication code.

Some examples of the method, apparatus, non-transitory computer-readable medium, and system described above further include receiving user input initiating an offline authentication mode, wherein the authentication signal is generated according to the offline authentication mode. Some examples of the method, apparatus, non-transitory computer-readable medium, and system described above further include displaying a code entry page, wherein the authentication code is received via the code entry page.

Some examples of the method, apparatus, non-transitory computer-readable medium, and system described above further include determining that the authentication code is valid, wherein the user is authenticated based on the determination. Some examples of the method, apparatus, non-transitory computer-readable medium, and system described above further include registering the electronic device for offline authentication, wherein the private encryption key and the public encryption key are generated based on the registration of the electronic device.

Some examples of the method, apparatus, non-transitory computer-readable medium, and system described above further include registering an additional device for offline authentication, wherein an additional private encryption key and an additional public encryption key are generated based on the registration of the additional device. Some examples further include generating an additional authentication signal encrypted using the additional public encryption key. Some examples further include displaying an additional machine-readable optical label representing the additional authentication signal to the electronic device.

An apparatus for offline authentication using an electronic device is described. Embodiments of the apparatus are configured to an offline authentication component configured to receive an authentication signal and to generate an authentication code based on the authentication signal, wherein the authentication signal is encrypted using a public key and encoded as a machine-readable optical label and a hardware security module configured to decrypt the authentication signal using a private encryption key generated with the public key.

A system for offline authentication is described. The system includes an offline authentication component configured to receive an authentication signal and to generate an authentication code based on the authentication signal, wherein the authentication signal is encrypted using a public key and encoded as a machine-readable optical label and a hardware security module configured to decrypt the authentication signal using a private encryption key generated with the public key.

Some examples of the apparatus, system, and method described above further include a camera configured to capture an image of the machine-readable optical label. In some examples, the machine-readable optical label comprises a QR code. In some examples, the offline authentication component is further configured to receive user input initiating an offline authentication mode, wherein the authentication signal is received according to the offline authentication mode.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a DSP, an ASIC, a FPGA or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media with any medium that facilitates the transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for user authentication, comprising:
receiving an authentication signal, wherein the authentication signal is encrypted using a public encryption key and encoded as a machine-readable optical label;
decrypting the authentication signal using a private encryption key, wherein the private encryption key is generated together with the public key and stored in a hardware security module of an electronic device; and
generating an authentication code based on the decrypted authentication signal.

2. The method of claim 1, further comprising:
receiving user input initiating an offline authentication mode, wherein the authentication signal is received according to the offline authentication mode.

3. The method of claim 1, further comprising:
determining that an unlocking process has been completed for the electronic device containing the hardware security module, wherein the authentication code is generated based on the determination.

4. The method of claim 1, further comprising:
accessing a camera of the electronic device; and
capturing an image of the machine-readable optical label using the camera.

5. The method of claim 1, further comprising:
decoding the machine-readable optical label to obtain a digital representation of the authentication signal, wherein the authentication signal is decrypted based on the digital representation.

6. The method of claim 1, further comprising:
entering the authentication code into a code entry page displayed on an external device.

7. The method of claim 1, further comprising:
registering the electronic device for offline authentication, wherein the private encryption key and the public encryption key are generated based on the registration of the electronic device.

8. The method of claim 1, further comprising:
registering an additional device for offline authentication, wherein an additional private encryption key and an additional public encryption key are generated based on the registration of the additional device;
receiving an additional authentication signal encrypted using the additional public encryption key;
attempting to decrypt the additional authentication signal encrypted using the private encryption key stored in the local hardware security module of the electronic device; and
determining that the additional authentication signal is invalid based on the attempted decryption.

9. The method of claim 1, wherein:
the machine-readable optical label comprises a Quick Response (QR) code.

10. The method of claim 1, wherein:
the authentication code comprises a one-time numerical code.

11. A method for user authentication, comprising:
generating an authentication signal using a public encryption key;
displaying a machine-readable optical label representing the authentication signal to the electronic device;
receiving an authentication code from the electronic device in response to displaying the machine-readable optical label, wherein the authentication code is generated using a private encryption key generated together with the public key and stored in a local hardware security module of an electronic device; and
authenticating a user based on the authentication code.

12. The method of claim 11, further comprising:
receiving user input initiating an offline authentication mode, wherein the authentication signal is generated according to the offline authentication mode.

13. The method of claim 11, further comprising:
displaying a code entry page, wherein the authentication code is received via the code entry page.

14. The method of claim 11, further comprising:
determining that the authentication code is valid, wherein the user is authenticated based on the determination.

15. The method of claim 11, further comprising:
registering the electronic device for offline authentication, wherein the private encryption key and the public encryption key are generated based on the registration of the electronic device.

16. The method of claim 15, further comprising:
registering an additional device for offline authentication, wherein an additional private encryption key and an additional public encryption key are generated based on the registration of the additional device;
generating an additional authentication signal encrypted using the additional public encryption key; and
displaying an additional machine-readable optical label representing the additional authentication signal to the electronic device.

17. An apparatus for user authentication, comprising:
an offline authentication component configured to receive an authentication signal and to generate an authentication code based on the authentication signal, wherein the authentication signal is encrypted using a public key and encoded as a machine-readable optical label; and
a hardware security module configured to decrypt the authentication signal using a private encryption key that is generated together with the public key.

18. The apparatus of claim 17, further comprising:
a camera configured to capture an image of the machine-readable optical label.

19. The apparatus of claim 17, wherein:
the machine-readable optical label comprises a Quick Response (QR) code.

20. The apparatus of claim 17, wherein:
the offline authentication component is further configured to receive user input initiating an offline authentication mode, wherein the authentication signal is received according to the offline authentication mode.
